(19) United States
(12) Patent Application Publication
(10) Pub. No.: US 2026/0196787 A1
(43) Pub. Date: Jul. 9, 2026

(54) Terminal Block Wire Installation System

(71) Applicant: The Boeing Company, Arlington, VA (US)

(72) Inventors: Yakentim M. Ibrahim, Brier, WA (US); Mohammad Hamed Hashimi, Bellevue, WA (US)

(21) Appl. No.: 19/014,634

(22) Filed: Jan. 9, 2025

(51) Int. Cl. H01R 43/00

(52) U.S. Cl. CPC H01R 43/00; H01R 2201/26

(57) ABSTRACT

A system configured to assist an operator that is inserting wires into terminal block cavities that are connected to electrical equipment. The system includes a computing device that accesses one or more data tables. The data tables identify the wires and the corresponding terminal block where the wires are to be connected. The computing device is configured to create a plug map based on the one or more data tables. The plug map is a digital visualization that replicates the configuration of terminal blocks. The plug map is configured to be displayed as a graphical user interface on a monitor. During use, the computing device highlights the cavity to enable the operator to connect the wire to the correct terminal block.

### TECHNOLOGICAL FIELD

The present disclosure relates generally to the field of wire installation and, more specifically, to systems and methods to facilitate an operator to correctly terminate wires to terminal blocks.

### BACKGROUND

Electrical equipment is often stored within a room or area within a building or vehicle. One specific example is an electrical room within an aircraft that houses the aircraft's electrical equipment. Terminal blocks are positioned to connect and secure wires to the electrical equipment. The terminal blocks include an insulated body constructed from a non-conductive material such as plastic. Cavities are positioned in the bodies to enable termination of the wires. The wires can be used for various purposes, such as power distribution, signal routing, and control wiring. The wires have an exposed end which is called contacts that is configured to be inserted and connected to one of the cavities of the terminal block. The wires are often bundled together and is called a wire bundle.

An electrical room is often configured to house multiple different pieces of electrical equipment. The equipment is stored in cabinets that are referred to as electrical shelves. The electrical shelves can have various sizes. The terminal blocks are riveted to the structure of the shelves and are aligned in rows along the back of the cabinets. For large electrical rooms that house a number of different electrical equipment, the terminal blocks are aligned in multiple rows and columns that are horizontally and vertically aligned. The terminal blocks include cavities to connect with wires thus forming a matrix of possible connection locations for the wires.

The insertion process requires an operator to identify each particular wire and then match the wire to the correct cavity in a terminal block. The operator then inserts the exposed end of the wire into the cavity and secures it in position. The location information for each wire is often provided on a listing that also includes the connection for multiple different terminal blocks. It is relatively easy for an operator to insert a wire into an incorrect cavity because they are required to look between the listing which is printed on a hard copy or appears on a monitor screen, and then look to the terminal blocks to determine the location. Further, there is no indication on the terminal blocks or its tracks regarding the correct cavity.

There is a need to facilitate the connection process to enable an operator to correctly connect the wires to the terminal blocks.

### SUMMARY

One aspect is directed to a method of inserting wires into cavities of terminal blocks and implemented by a terminal block wire installation system. The method comprises: outputting a signal to a monitor to include a display of a plug map with the display being visually similar to a pattern of the terminal blocks; receiving an input that identifies one of the wires; determining which one of the cavities of the terminal blocks corresponds to the wires; and highlighting the terminal block to enable an operator to insert the wire to the terminal block.

In another aspect, the method further comprises accessing one or more data tables and creating the plug map based on data from the one or more data tables.

In another aspect, highlighting the terminal block comprises displaying on the display the terminal block in a different visual manner than a remainder of the terminal blocks.

In another aspect, highlighting the terminal block comprises turning off one or more other lights that illuminate the other terminal blocks.

In another aspect, the method further comprises illuminating just the terminal block that corresponds to the wire and not illuminating a remainder of the other terminal blocks.

In another aspect, the method further comprises converting one or more data tables into the plug map.

In another aspect, highlighting the terminal block comprising highlighting one or more cavities of the terminal block that correspond to the wire.

In another aspect, the method further comprises receiving an input indicating a bundle in which the wire is part of.

In another aspect, the method further comprises receiving an indication that wiring of the terminal block is completed and updating one or more data tables.

In another aspect, the method further comprises receiving an identification of equipment that includes the terminal blocks prior to outputting the signal to the monitor of the display.

One aspect is directed to a computing device configured to assist an operator with inserting wires into terminal blocks. The computing device comprises processing circuitry and memory circuitry comprising program instructions and one or more data tables with the program instructions when executed by the processing circuity configures the computing device to: display a plug map of the terminal blocks with the plug map visually corresponding to the terminal blocks that are in view of the operator; receive an input that identifies one of the wires; determine which one of the terminal blocks corresponds to the wires; and highlight the terminal block to assist the operator in inserting the wire.

In another aspect, a light is configured to connect to the terminal blocks and wherein the light illuminates the terminal block to highlight the terminal block to assist the operator in inserting the wire.

In another aspect, the light comprises: a body comprising a printed circuit board; a plurality of LEDs mounted across the body; and tabs that extend outward from the body and are configured to engage with the terminal blocks.

In another aspect, the processing circuitry further configures the computing device to update one or more data tables after receiving an indication that wiring is completed.

In another aspect, the processing circuitry further configures the computing device to create the plug map based on the one or more data tables that include data lists.

One aspect is directed to a non-transitory computer readable medium storing a computer program product for controlling a computing device with the computer program product comprising software instructions that, when run on processing circuitry of the computing device, cause the computing device to: receive an identification of equipment; generate a display that visually corresponds to the equipment; transmit a signal to display the display on a monitor; receive an identification of a wire that is to be connected to the equipment; and illuminate a terminal block on the equipment where the wire is to be inserted.

In another aspect, the computing device is configured to highlight a visual terminal block on the display that corresponds to the terminal block on the equipment.

In another aspect, the computing device is configured to generate the display based on one or more data tables that comprise list data of the wire, the terminal block, and the equipment.

In another aspect, illuminating the terminal block on the equipment comprises illuminating a cavity on the terminal block.

In another aspect, the computing device is configured to receive an input that the wire has been inserted in the terminal block and updating a data table stored at the computing device.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a terminal block wire installation system for connecting wires to terminal blocks 110.

FIG. 2 is a side view of bundles of wires connected to terminal blocks of equipment.

FIG. 3A is a schematic diagram of a terminal block.

FIG. 3B is a schematic diagram of a terminal block.

FIG. 4 is a diagram of a data table illustrated in a list form.

FIG. 5 is a schematic diagram of a display of a plug map with the plug map based on data from one or more data tables.

FIG. 5A is a schematic diagram of the plug map of FIG. 5.

FIG. 6 is a schematic diagram of a display of a terminal block with the terminal block being visually highlighted.

FIG. 7 is a schematic diagram of a light mount in proximity to terminal blocks.

FIG. 8 is an isometric diagram of a light configured to be connected at terminal blocks.

FIG. 9A is a schematic diagram of a computing device.

FIG. 9B is a schematic diagram of a computing device and a separate light controller.

FIG. 10 is a flowchart diagram of a method of displaying connection information to connect a wire to a terminal block.

FIG. 11 is a flowchart diagram of a method of displaying connection information to connect a wire to a terminal block.

FIG. 12 is an isometric view of an aircraft that includes an electronics bay.

### DETAILED DESCRIPTION

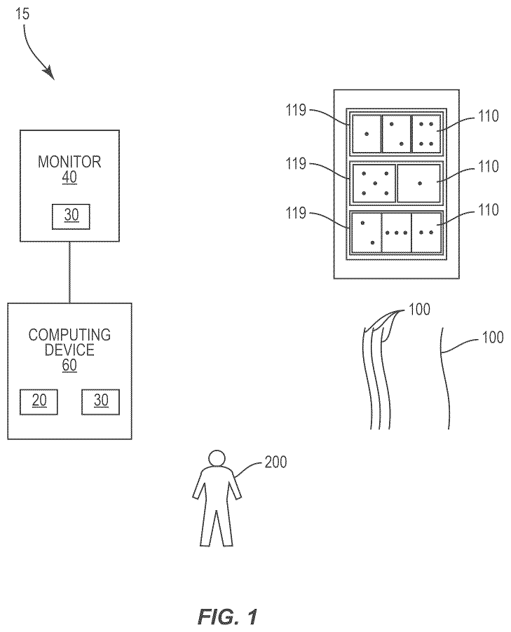

FIG. 1 illustrates an overview of the terminal block wire installation system 15 (hereinafter system 15). The system 15 is configured to assist an operator 200 that is installing wires 100 into terminal blocks 110 that are connected to electrical equipment 119. The system 15 includes a computing device 60 that accesses one or more data tables 20. The data tables 20 identify the wires 100 and the corresponding terminal block 110 where the wires 100 are to be inserted. The computing device 60 is configured to create a plug map 30 based on the one or more data tables 20. The plug map 30 is a digital visualization that replicates the configuration of terminal blocks 110. The plug map 30 is configured to be displayed as a graphical user interface on a monitor 40. During use, the operator 200 inputs the identification of a wire 100. The computing device 60 determines the corresponding cavity of the terminal block 110 where the wire 100 is to be terminated. The computing device 60 highlights the cavity to enable the operator 200 to insert the wire 100 in the correct terminal block 110.

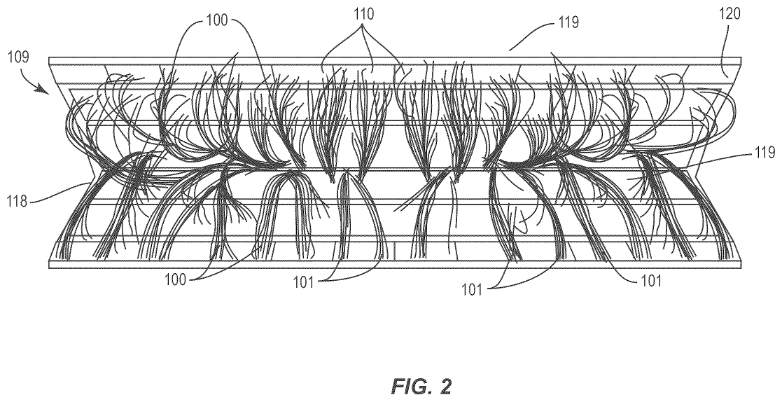

FIG. 2 illustrates an example of wires 100 that are terminated to terminal blocks 110. The wires supply electrical power, data, and/or communication signaling with the equipment 119. The wires 100 each include an exposed distal end that are configured to be inserted in one of the terminal blocks 110. The wires 100 are often organized into bundles 101 that include multiple wires 100 that are to be connected to the equipment 119. In some examples, the bundles 101 include wires 100 that are each terminate at a single terminal block 110 or two or more adjacent terminal blocks 110.

In some examples as illustrated in FIG. 2, the equipment 119 is aligned along shelves 118. The shelves 118 position the equipment 119 in various vertical and horizontal configurations. The terminal blocks 110 that are connected to the equipment 119, often along a back side, are likewise arranged in an array 109 that include horizontal lines and vertical stacks.

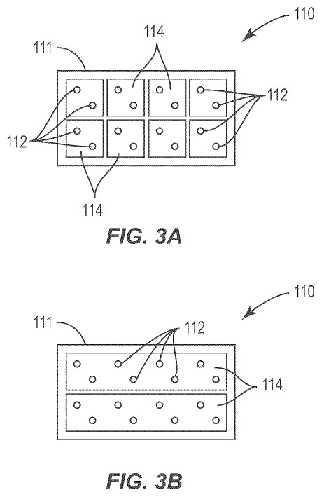

The terminal blocks 110 are configured to splice together multiple wires 100. The number of wires 100 that are spliced together varies, with examples including but not limited to a range of between two-eight wires 100. As illustrated in FIG. 3A, the terminal blocks 110 each include a body 111 usually constructed from a non-conductive material such as plastic. The front side of the body 111 includes one or more chambers 114 that each include one or more cavities 112. The number of chambers 114 can vary with FIG. 3A including an example with eight chambers 114 and FIG. 3B having two chambers 114. The number of cavities 112 within the chambers 114 can vary. In some examples, the chambers 114 of each terminal block 110 is divided into four columns spaced apart across the length of the terminal block 110. The different chambers 114 can have various configurations and numbers of cavities 112.

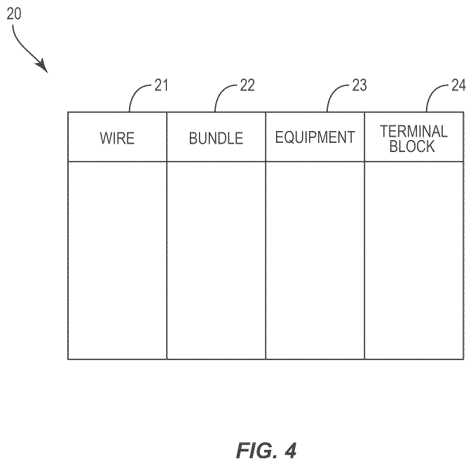

Data tables 20 include information indicating the connections for the wires 100. FIG. 4 illustrates an example of the content of a data table 20 displayed in a list format. The data table 20 can include various numbers of rows. In this example, each row of the list corresponds to a wire 100 (which is identified in a wire column 21), the corresponding bundle 101 for the wire 100 (which is listed in a bundle column 22), the equipment 119 (which is listed in column 23), and the terminal block 110 (which is listed in column 24). In some examples, the cavity 112 is listed for each wire 100. The physical arrangement that includes the array 109 of the equipment 119 and terminal blocks 110 is also maintained in one or more data tables 20. The data tables 20 can be stored in a variety a different formats.

The computing device 60 performs dynamic parsing of the data tables 20 to build the plug map 30. The plug map 30 is a visual representation of the content that is documented in list form from the data tables 20. The plug map 30 is then converted to a display 90 formatted to appear on the monitor 40. The display 90 corresponds to the physical array that the operator 200 is visually observing with the actual equipment 119. In some examples, the display 90 is a graphical user interface (GUI) that enables the operator 200 to interact with the display through one or more icons, buttons, and menus.

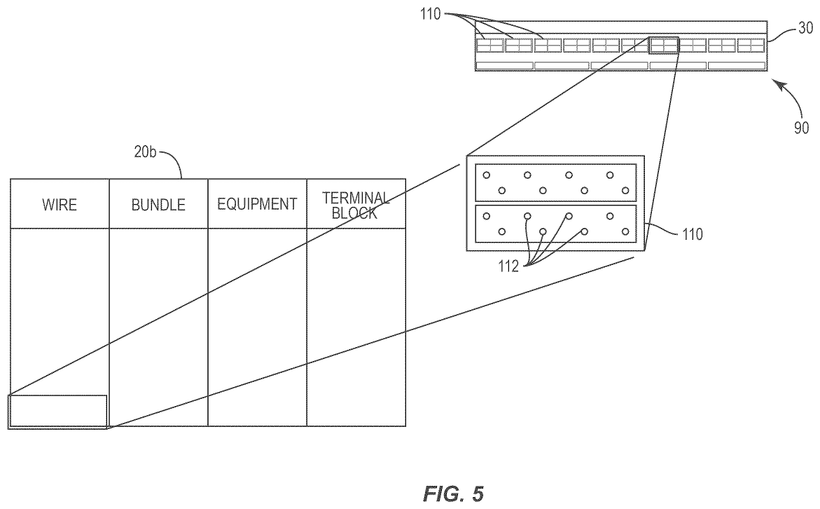

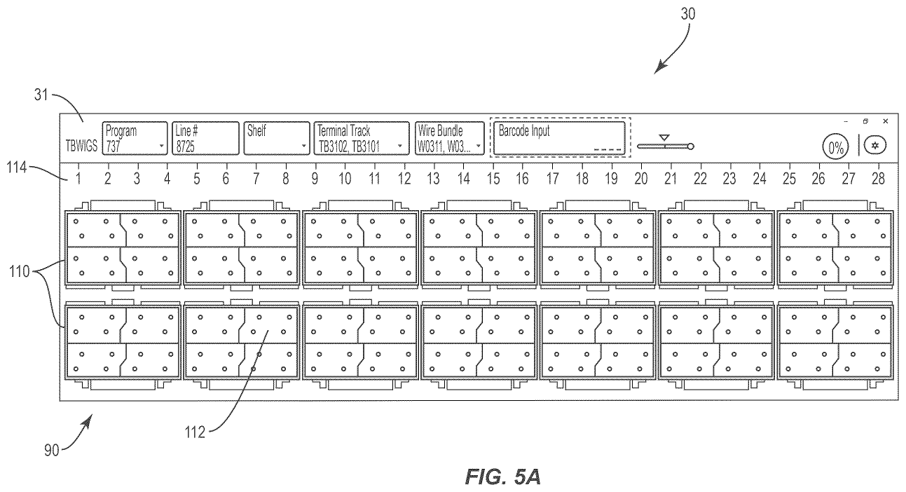

FIG. 5 illustrates an example of a display 90 of a plug map 30 that is displayed as a GUI on the monitor. The plug map 30 was generated based on one or more data tables 20b. The display 90 visually matches the appearance of the terminal blocks 110 that are connected to the equipment 119. In some examples, the display 90 includes the terminal blocks 110 of the entire array 109 of equipment 119. In other examples, the display 90 includes just a limited number of terminal blocks 110, such as the terminal blocks 110 that are connected to one piece of equipment 119.

During use as illustrated in FIG. 5A, the plug map 30 is generated and a signal is sent to the monitor to display the corresponding display 90. The operator 200 enters one or more inputs 31 that identify one of the wires 100. Examples of inputs include but are not limited to a program (e.g., specific aircraft, specific machinery), a line number, a shelf, terminal track, wire bundle, and barcode input of the wire or bundle. The corresponding chamber 114 and one or more cavities 112 of the terminal block 110 where the wire 100 is to be inserted is highlighted. In some examples, the display 90 includes a highlight 91 of the corresponding cavity 112 to visually distinguish it relative to the other cavities 112 to indicate to the operator 200 where the wire 100 is to terminate. The display 90 includes a row that identifies the chambers 114. The chambers 114 are sequentially numbered from left to right as shown in the display. In this example, each terminal block 110 includes four chambers 114. The one or more chambers 114 where the selected wire 100 is inserted are highlighted as well as the row numbers. In the example of FIG. 5A, the wire terminates in a cavity of chamber row 7 or 8.

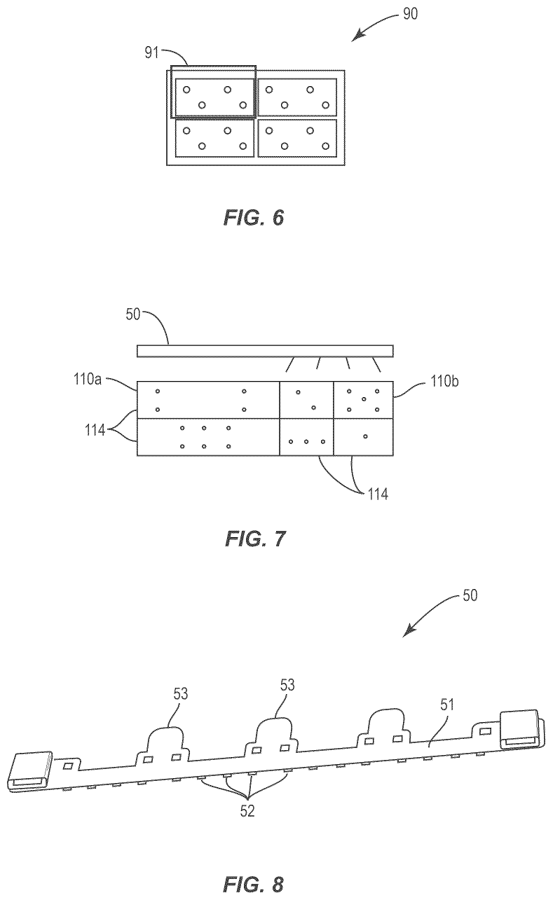

FIG. 6 illustrates another example of highlighting of the corresponding chamber 114 and cavities 112. In this example, the highlight 91 is a frame that extends around the cavities of the corresponding chamber. Another example includes displaying the corresponding chamber and cavities in a different color than the other cavities 112.

In some examples of using the system, the operator 200 enters one or more inputs 31 that identify the wire 100. The display 90 highlights the corresponding chamber 114 and cavities 112 where the wire 100 is to be inserted. In some examples, the operator 200 moves a cursor on the display 90 over a cavity 112 and/or chamber 114 resulting in a pop-up list of the wires 100 that are associated with the terminal block 110. In some examples, the tables are updated in a window and not in a pop-up list.

In some examples, the operator 200 moves a cursor on the display 90 to an area in the chamber 114 that is between cavities 112. This results in a menu being displayed that enables the operator 200 to log and save their progress. Once the wiring for a terminal block 110 is completed, the data is updated on the menu.

In some examples, the system 15 includes one or more lights 50 to illuminate the terminal block 110. FIG. 7 illustrates an example with a light 50 positioned adjacent to the array 109 that includes terminal blocks 110a, 110b. The light 50 is configured to illuminate the terminal block 110 that corresponds to the wire 100 that is identified by the operator 200. In the example of FIG. 7, the light 50 illuminates terminal block 110b. In some examples, the light 50 is configured to illuminate a specific chamber 114 of the terminal block 110. The lights 50 are positioned adjacent to the terminal blocks 110 and can be connected to one or more of the equipment 119, shelf 118, or a surrounding structure.

The light 50 can include a variety of different constructions. In some examples, the light 50 is an LED light strip with a length to extend along the array 109. The light strip is configured to emit light to one or more of the individual terminal blocks 110 and/or chambers 114. In another example, the light 50 includes an array of LEDs.

In some examples, the lights 50 are configured to be mounted to the equipment 119/terminal blocks 110 by the operator 200 prior to connecting the wires 100. FIG. 8 includes a light 50 with a printed circuit board 51 having an elongated length. LEDs 52 are mounted along the length. Tabs 53 extend outward from the printed circuit board 51. During use, the operator 200 aligns the light 50 with the terminal blocks 110. The tabs 53 are inserted into slots to secure the light 50. The light 50 is aligned to enable the LEDs 52 to illuminate the individual chambers 114 and/or cavities 112.

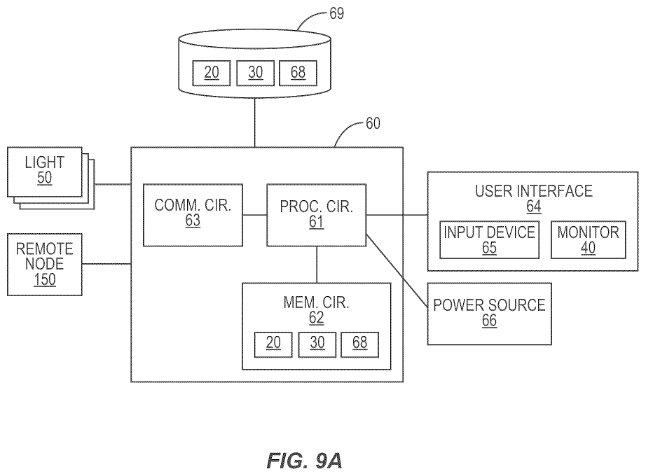

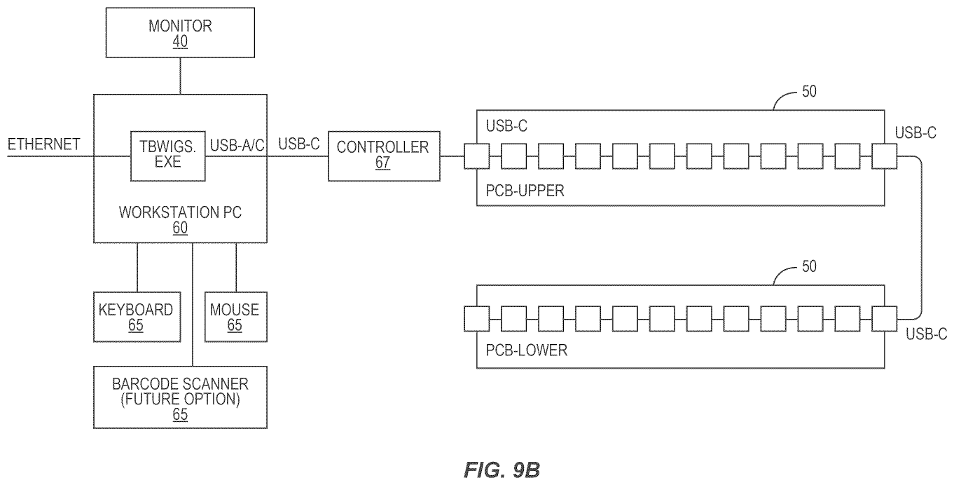

The system 15 includes a computing device 60. FIG. 9A illustrates an example with the computing device 60 having processing circuitry 61 that controls the operation of the system 15 according to program instructions 68 stored in memory circuitry 62. The processing circuitry 61 can include one or more circuits, microcontrollers, microprocessors, hardware, or a combination thereof. Memory circuitry 62 includes a non-transitory computer readable storage medium storing program instructions, such as a computer program product, that configures the processing circuitry 61 to implement one or more of the techniques discussed herein. Memory circuitry 62 can include various memory devices such as, for example, read-only memory, and flash memory. Memory circuitry 62 can be a separate component as illustrated in FIG. 9 or can be incorporated with the processing circuitry 61. Alternatively, the processing circuitry 61 can omit the memory circuitry 62, e.g., according to at least some examples in which the processing circuitry 61 is dedicated and non-programmable.

In some examples, a database 69 stores information about the process such as but not limited to the data tables 20, plug maps 30, and program instructions 68. The database 69 is stored in a non-transitory computer readable storage medium (e.g., an electronic, magnetic, optical, electromagnetic, or semiconductor system-based storage device). The database 69 can be local or remote relative to the computing device 60.

Communications circuitry 63 enables communications to and from the various elements, such as but not limited to lights 50 and remote nodes 150. Communications can include both incoming and outgoing communications. The communications circuitry 63 can include one or more interfaces that provide for different methods of communication. Examples include but are not limited to a cellular interface that enables communication with a mobile communication network, a WLAN interface configured to communicate with a local area network, and a personal area network interface, such as a Bluetooth interface. In some examples, communication circuitry 63 enables communications through hardwired transmissions.

A user interface 64 provides for an operator 200 to input and receive data. The user interface 64 can include one or more input devices 65 such as but not limited to a keypad, touchpad, roller ball, scanner, and joystick. The one or more input devices 65 provide for the operator 200 to enter commands during the process. The user interface 64 can also include one or more monitors 40 for displaying information to the operator 200, such as the graphical user interfaces of the plug maps 30. The user interface 64 enables the operator 200 to enter information through the GUI display 90.

A power source 66 provides power to the computing device 60. The power source 66 can include various configurations, including but not limited to batteries. The power source 66 can include a connector to provide a hardwire connection to an external power source (e.g., electrical power from the surrounding structures).

In some examples, a remote node 150 is able to communicate with the computing device 60 to access information about the process. In some examples, the computing device 60 is configured to enable access by the remote node 150 using a browser-based interface or an applications program interface (API). The browser-based interface can include a website through which the contents of the memory circuity 62 and/or database 69 can be accessible. In some examples, the remote nodes 150 access the computing device 60 through a public data network, or alternatively some other network.

In some examples, the computing device 60 includes a light controller. The light controller can be a separate component or can be incorporated in the processing circuitry 61. The light controller is configured to drive lights 50 that include one or more LED arrays. The arrays include printed circuit boards that are mounted proximate to the cavities 112. In some examples, the LEDs are connected by daisy chaining.

FIG. 9B illustrates another example with a light controller 67 that is separate from the processing circuitry of the computing device 60 (which in this example is a workstation computer). The light controller 67 includes processing and memory circuitry to control the operation of one or more lights 50. In some examples as illustrated in FIG. 9B, the lights 50 are daisy-chained together. The computing device 60 includes the components as described above in FIG. 9A. The computing device 60 is configured to communicate with one or more of a remote node and database (not illustrated in FIG. 9B).

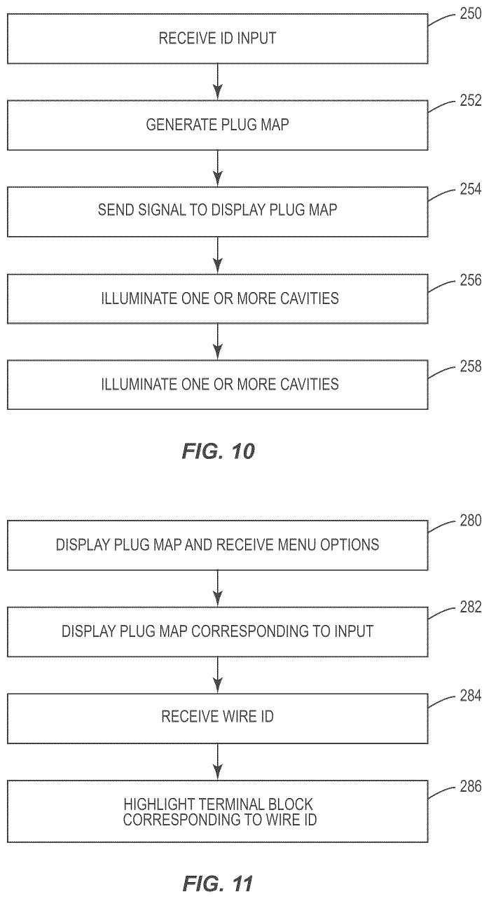

FIG. 10 illustrates an example of the operation of the system 15 based on inputs from an operator 200. The computing device 60 receives an input identifying the equipment 19 (block 250). In some examples, the input includes one or more of a program, a line, and a shelf. Based on the input, a plug map 30 of the equipment and corresponding terminal blocks is generated (block 252). A corresponding display signal is sent to a monitor 40 to display the data in a visual format the corresponds to the actual equipment that is being serviced by the operator 200 (block 254).

The computing device 60 then receives an input from the operator 200 indicating a bundle 101 and a wire 100 (block 256). The computing device 60 determines the one or more corresponding cavities and illuminates the cavities (block 258). In some examples, the one or more chambers 114 are illuminated.

In some examples, the computing device 60 updates the data indicating the status of the one or more wires 100 and bundles 101.

FIG. 11 illustrates a method of the operator 200 using the system 15 to connect wires 100 to the terminal blocks 110. The operator 200 accesses the GUI display 90 and selects options from a menu (block 280). One option includes the operator 200 inputting the shelf/panel where he is working. In one example in which the operator 200 is working on an aircraft, this includes the airplane model and the line number of the terminal blocks 110. The selection enables the computing device 60 to retrieve the data from the one or more data tables 20, such as but not limited to the track orientation data and the terminal block configurations.

The display 90 is configured to display the terminal block tracks for the selected shelf/panel (block 282). The display includes the tracks displayed in the same visual manner in which the actual terminal blocks 110 visually appear to the operator 200. In some examples, the display also includes terminal block codes and diode and resistor symbols. In some examples, the display 90 includes other tracks on the equipment 119 that are not being worked on by the operator 200. In other examples, the display 90 includes just the tracks that the operator 200 inputs and is working on.

In some examples, the operator 200 installs one or more lights 50 on the terminal blocks 110 and/or equipment 119. In other examples, the one or more lights 50 are already installed.

The operator 200 inputs a wire ID (block 284). The manner of input may vary with examples including but not limited to scanning a barcode on the wire, and manually inputting the identification through a keyboard. In some examples, the operator 200 also inputs the bundle 101 for the wire 100.

In response to receiving the wire ID, the display 90 highlights the terminal block 110 where the wire 100 is to be connected (block 286). In some examples, this includes illuminating the section of the terminal block 110 and/or highlighting the corresponding section on the display 90. In some examples, the illumination by the one or more lights 50 just occurs at the relevant position as the other lights 50 are turned off. With the relevant terminal block 110/chamber 114/cavity 112 illuminated, the operator 200 is able to insert the wire 100 at the correct position.

The operator 200 repeats the process for the other wires 100 to obtain the fully connected terminal blocks 110/equipment 119. Once completed, the operator 200 removes the one or more lights 50. In some examples, the operator 200 installs resistors and diodes as needed. The operator 200 can also insert ground wires as needed.

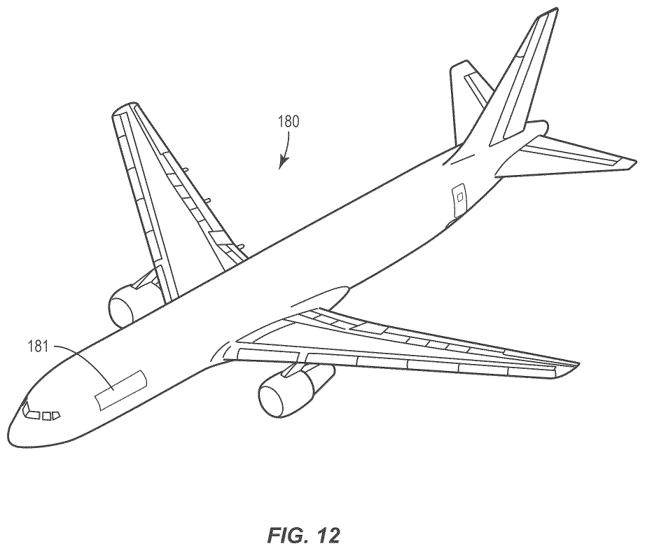

The system 15 can be used for connecting wires in a variety of different environments and contexts. These various situations include a relatively large number of wires 100 that are connected to equipment 119 concentrated in a relatively small area. One example is an electronics equipment bay 181 located onboard an aircraft 180 as illustrated in FIG. 12. In some examples as illustrated in FIG. 12, the electronics equipment bay 181 is located forward of the cargo area in proximity to the flight deck. The electronics equipment bay 181 includes electrical equipment that is mounted on cabinets that extend within the bay 181.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of inserting wires into cavities of terminal blocks, implemented by a terminal block wire installation system, the method comprising:
outputting a signal to a monitor to include a display of a plug map, the display being visually similar to a pattern of the terminal blocks;
receiving an input that identifies one of the wires;
determining which one of the cavities of the terminal blocks corresponds to the wires; and
highlighting the terminal block to enable an operator to insert the wire into the terminal block.

2. The method of claim 1, further comprising:
accessing one or more data tables; and
creating the plug map based on data from the one or more data tables.

3. The method of claim 1, wherein highlighting the terminal block comprises displaying on the display the terminal block in a different visual manner than a remainder of the terminal blocks.

4. The method of claim 1, wherein highlighting the terminal block comprises turning off one or more other lights that illuminate other ones of the terminal blocks.

5. The method of claim 4, further comprising illuminating just the terminal block that corresponds to the wire and not illuminating a remainder of the other terminal blocks.

6. The method of claim 1, further comprising converting one or more data tables into the plug map.

7. The method of claim 1, wherein highlighting the terminal block comprising highlighting one or more cavities of the terminal block that correspond to the wire.

8. The method of claim 1, further comprising receiving an input indicating a bundle in which the wire is part of.

9. The method of claim 1, further comprising:
receiving an indication that wiring of the terminal block is completed; and
updating one or more data tables.

10. The method of claim 1, further comprising receiving an identification of equipment that includes the terminal blocks prior to outputting the signal to the monitor of the display.

11. A computing device configured to assist an operator with inserting wires into terminal blocks, the computing device comprising:
processing circuitry; and
memory circuitry comprising program instructions and one or more data tables, the program instructions when executed by the processing circuity configures the computing device to:
display a plug map of the terminal blocks with the plug map visually corresponding to the terminal blocks that are in view of the operator;
receive an input that identifies one of the wires;
determine which one of the terminal blocks corresponds to the wires; and
highlight the terminal block to assist the operator in inserting the wire.

12. The computing device of claim 11, further comprising a light configured to connect to the terminal blocks and wherein the light illuminates the terminal block to highlight the terminal block to assist the operator in inserting the wire.

13. The computing device of claim 12, wherein the light comprises:
a body comprising a printed circuit board;
a plurality of LEDs mounted across the body; and
tabs that extend outward from the body and are configured to engage with the terminal blocks.

14. The computing device of claim 11, wherein the processing circuitry further configures the computing device to update one or more data tables after receiving an indication that wiring is completed.

15. The computing device of claim 11, wherein the processing circuitry further configures the computing device to create the plug map based on the one or more data tables that includes data lists.

16. A non-transitory computer readable medium storing a computer program product to control a computing device, the computer program product comprising software instructions that, when run on processing circuitry of the computing device, cause the computing device to:
receive an identification of equipment;
generate a display that visually corresponds to the equipment;
transmit a signal to display the display on a monitor;
receive an identification of a wire that is to be connected to the equipment; and
illuminate a terminal block on the equipment where the wire is to be inserted.

17. The non-transitory computer readable medium of claim 16, further comprising the computing device configured to highlight a visual terminal block on the display that corresponds to the terminal block on the equipment.

18. The non-transitory computer readable medium of claim 16, further comprising the computing device configured to generate the display based on one or more data tables that comprise list data of the wire, the terminal block, and the equipment.

19. The non-transitory computer readable medium of claim 16, wherein illuminating the terminal block on the equipment comprises illuminating a cavity on the terminal block.

20. The non-transitory computer readable medium of claim 16, further comprising the computing device configured to receive an input that the wire has been inserted in the terminal block and updating a data table stored at the computing device.
